(19) United States
(12) Patent Application Publication
(10) Pub. No.: US 2007/0283818 A1
(43) Pub. Date: Dec. 13, 2007

(54) Adjustable Cover Assembly

(75) Inventors: Steven W. Hockema, Fort Wayne, IN (US); Claude Brane, La Fontaine, IN (US); Rex G. Forbes, Fort Wayne, IN (US); Robert W. Huddleston, Wabash, IN (US)

Correspondence Address: BARNES & THORNBURG LLP, 600 ONE SUMMIT SQUARE, FORT WAYNE, IN, 46802, US

(73) Assignee: THE FORD METER BOX COMPANY, Wabash, IN (US)

(21) Appl. No.: 11/760,220

(22) Filed: Jun. 8, 2007

Related U.S. Application Data
(60) Provisional application No. 60/812,289, filed on Jun. 9, 2006.

(51) Int. Cl. A47J 31/02

(52) U.S. Cl. 99/316; 220/912

(57) ABSTRACT

A pit cover assembly having a base and a plurality of surfaces is provided. The base includes a hole disposed therethrough and has first and second surfaces. The plurality of surfaces extend from the first surface of the base, are spaced apart from each other, and are configured to engage a pit wall. Each of these surfaces is located on the first surface of the base a radial distance from the hole. At least one of the surfaces is radially adjustable with respect to the hole.

### RELATED APPLICATIONS

The present application is related to and claims priority to U.S. Provisional Patent Application Ser. No. 60/812,289, filed on Jun. 9, 2006, entitled “Adjustable Cover Assembly.” The subject matter disclosed in that provisional application is hereby expressly incorporated into the present application.

### TECHNICAL FIELD

The present disclosure relates to pipe or pit cover assemblies and more particularly to pit cover assemblies that protect meters or other structures from the elements while allowing access to the meters or other structures for reading and/or replacement/repair.

### BACKGROUND AND SUMMARY

In order to determine how much water is being used at a particular location, a meter is attached to the pipe supplying the water. Often the water pipe is in the ground requiring the meter to be in the ground as well. To accommodate this, a pit is formed in the ground to contain the meter or other structures. This meter or other structures, however, needs to be accessible in order to be read either visually or electronically, for example, or to be inspected and/or repaired. Selective access to the meter or other structures is, therefore, necessary for accomplishing these tasks. At the same time, since the meter other structures will be in the ground, it is subject to a harsh environment that could adversely impact the meter or other structures. Accordingly, pit covers are a conventional device used to protect the opening of the pit. Typically, these pits are cylindrically shaped and can have any variety of diameters based on the requirements for the meter and other factors. As a consequence, pit covers of varying diameters are required to accommodate these various pit sizes. It would, therefore, be beneficial to provide a single cover that can accommodate a variety of pit diameters.

Accordingly, an illustrative embodiment of the present disclosure provides a pit cover assembly which comprises a base, a riser, and a plurality of surfaces. The base has a hole disposed therethrough and includes first and second surfaces. The riser extends from the base on the second surface and is located about the periphery of the hole. The plurality of surfaces extend from the first surface, are spaced apart from each other, and configured to engage a pit wall. Each of these surfaces is located on the first surface of the base a radial distance from the hole, and at least one of the surfaces is radially adjustable with respect to the hole.

In the above and other embodiments, the pit cover assembly may further comprise: the surfaces including the one radially adjustable surface, accommodate pits of various sizes to allow communication between the hole in the base and an opening of the pit; the radially adjustable surface is a cam that selectively adjusts radially from the hole to engage inside or outside wall of pits of various diameters; the cam being rotatable such that its radial length is changeable with respect to its radial position to the hole in the base so as to engage pits having various diameters; the cam being rotatable about an axis to change the radial length of the cam with respect to its radial distance from the hole; a pivot that extends through the base so the cam is adjustable from the second surface; the pivot being a fastener that extends through the base to the second surface; the fastener being accessible from the second surface of the base to adjust the cam; the plurality of surfaces, other than the adjustable surface, being fixed lugs; the plurality of fixed lugs are two fixed lugs each spaced apart from each other and spaced radially from the hole opposite the cam; each lug and the adjustable cam are configured to engage the inside or outside of a pit wall; the plurality of fixed lugs are two sets of two fixed lugs each spaced apart from each other and spaced radially from the hole opposite the cam; and wherein a first set of fixed lugs is configured to engage the pit, and a second set of fixed lugs is configured to engage the pit, each set (of two) of fixed lugs may be located at a different radius length from the hole opposite the cam.

Another illustrative embodiment of the pit cover assembly comprises a base, a plurality of lugs, and a cam. The base includes a hole disposed therethrough and first and second surfaces. The plurality of lugs extend from the first surface, are spaced apart from each other, and are radially spaced from the hole. The cam lug extends from the first surface at a pivot that rotates the cam lug. The cam lug also has a plurality of surface portions each having a unique radial distance from the pivot such that rotating the cam lug changes a radial distance from any one of the plurality of surface portions to the hole.

In the above and other embodiments, the pit cover assembly may further comprise: the pivot extending through the base being accessible from the second surface to adjust the cam lug from the second surface; and the pivot being a fastener that extends through the base to the second surface.

Another illustrative embodiment of the pit cover assembly comprises: a means for engaging and covering a pit; wherein the means for engaging and covering the pit includes an adjustment means for engaging pit walls of varying diameters. In select embodiments, the adjustment means for engaging the pit walls of varying diameters is adjustable exterior of the pit, while the cover assembly is resting on the top of the installed pit.

Additional features and advantages of the adjustable pit cover assembly will become apparent to those skilled in the art upon consideration of the following detailed description of the illustrated embodiment exemplifying the best mode of carrying out the adjustable pit cover assembly as presently perceived.

### BRIEF DESCRIPTION OF DRAWINGS

The present disclosure will be described hereafter with reference to the attached drawings which are given as non-limiting examples only, in which:

FIGS. 1a-g show several views of an illustrative embodiment of the frame portion of an adjustable pit cover assembly, as well as various attachment configurations to pit walls of various sizes in the underside views of FIGS. 1d-g;

FIGS. 2a-c are several views of an illustrative cam lug;

FIG. 3 is an underside view of an illustrative embodiment of a pit cover assembly demonstrating how it can couple to the periphery wall of a pipe;

FIG. 4 is another underside view of the pit cover assembly of FIG. 3 showing another attachment configuration to a pipe wall of different diameter than that shown in FIG. 3;

FIG. 5 is a top perspective view of the pit cover assembly depicting how the adjustment lug can be adjusted from the top surface of the assembly;

FIGS. 6-9 are perspective views showing a process of securing a pipe to the pit cover;

FIGS. 10-13 are underside perspective views showing the process of securing a pipe having a greater diameter than that shown in the progression views of FIGS. 6-9;

FIGS. 14a-d are several views of an alternate embodiment of an adjustable pit cover assembly;

FIGS. 15a-c are several views of another illustrative embodiment of an adjustable pit cover assembly;

FIGS. 16a-c are several views of yet another illustrative embodiment of an adjustable pit cover assembly; and

FIG. 17 is a side perspective view of an illustrative embodiment of an adjustable pit cover assembly that can be adjusted from the top side.

Corresponding reference characters indicate corresponding parts throughout the several views. The exemplification set out herein illustrates embodiments of the adjustable cover assembly, and such exemplification is not to be construed as limiting the scope of the adjustable cover assembly in any manner.

### DETAILED DESCRIPTION OF THE DRAWINGS

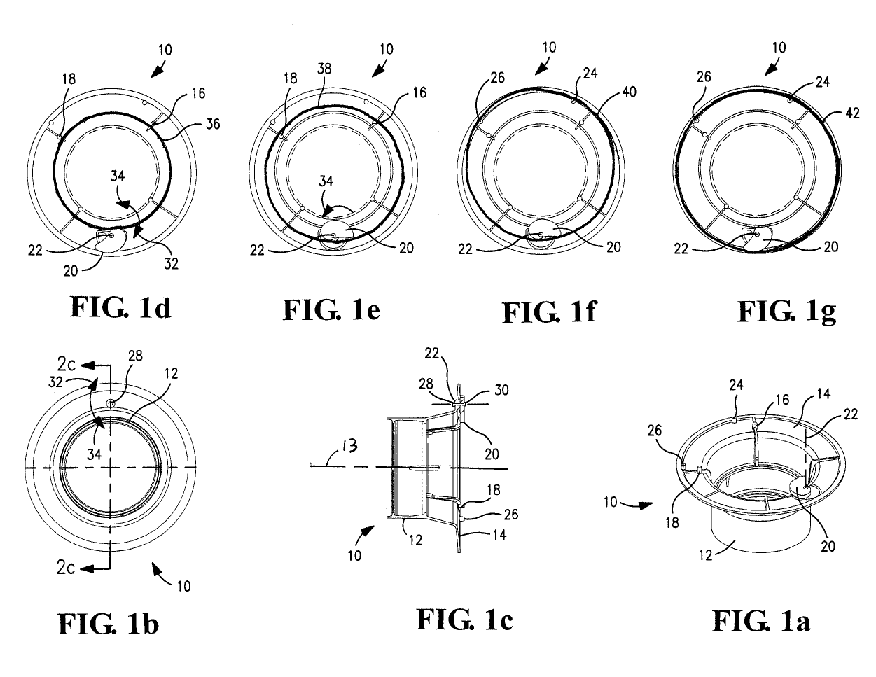

The several views of FIGS. 1a-g depict an illustrative embodiment of an adjustable frame 10 configured for use as part of a pit cover assembly adaptable to cover buried tiles or pipes of a variety of diameters. For purposes of this disclosure, reference to a pit means a pit known to those skilled in the art, including but not limited to vertically-oriented pipes and tubes. As shown in FIG. 1a, the underside view of adjustable frame 10 comprises a riser portion 12 and a base portion 14. A lid (not shown) can be placed on top of riser portion 12 to cover the opening. The underside of base portion 14 comprises first and second lugs or stops 16 and 18, respectively, and a cam 20 that rotates about axis 22. This embodiment of frame 10 further comprises alternate lugs stops 24 and 26. In one illustrative embodiment, first and second stops 16 and 18, along with cam 20, may be useful to engage a tile or pipe of particular diameter without the need of stops 24 and 26. Alternatively, for pipes of larger diameter, stops 24 and 26 can be used in conjunction with cam 20, rather than first and second stops 16 and 18. It can be appreciated that the precise configuration for either stops 16, 18, 24, and 26 extending from base 14 is illustrative. It is contemplated that in alternative embodiments, lugs or stops of other configurations, including surfaces having other geometric shapes, can be used instead. In further embodiments, stops 16 and 18 may be replaced with a single stop that can be adapted to achieve the same function as the stops shown herein. An illustrative purpose of the stops is to provide an abutment for a portion of the tile or pipe to engage, allowing the adjustable portion (in this embodiment, cam 20) to also engage the tile or pipe and horizontally position the cover assembly. Furthermore, cam 20 shown is also illustrative. It is appreciated that in other embodiments cam configurations or other adjustable structures can be used to engage tiles or pipes of a variety of sizes.

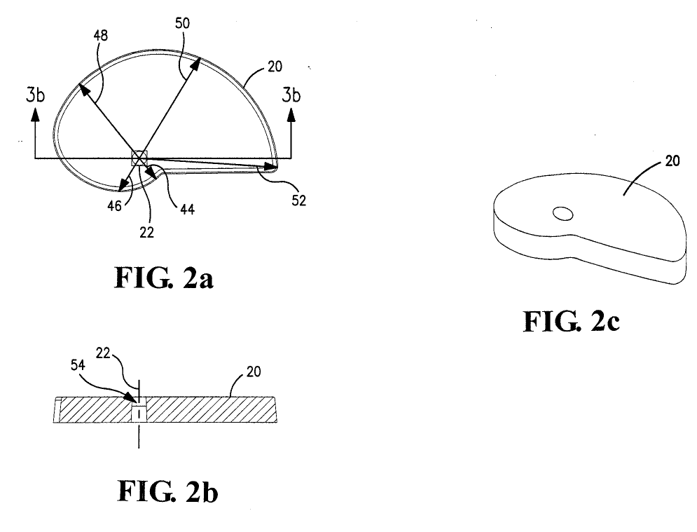

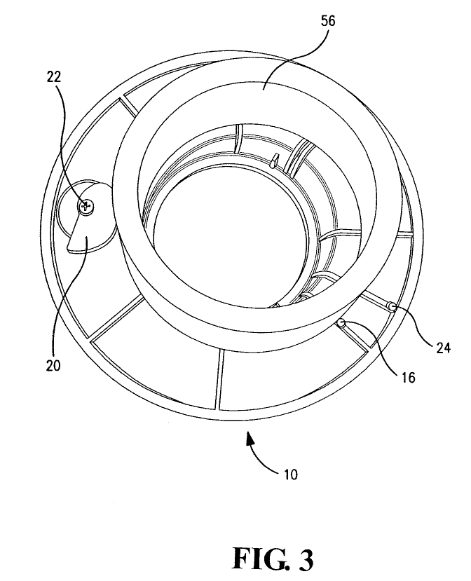

The top and side views shown in FIGS. 1b and c, respectively, further depict the illustrative configuration of frame 10. The top view of FIG. 1b shows frame 10 to be similar to conventional frames, including the configuration of riser 12. In this particular illustrative embodiment, a torque nut or head 28 is located on the top side of frame 10 to allow adjustment of cam 20 from the top side of frame 10, allowing proper adjustment/rotation of cam 20 and positioning of the cover assembly while cover assembly is setting on the tile or pipe. As shown in FIG. 1c, an illustrative carriage bolt 30 is disposed through cam 20 at its axis of rotation 22. (See, also, FIG. 1a.) Carriage bolt 30 is also illustratively disposed through base 14 and engages torque head 28. Thus, as illustratively shown, as nut 28 is rotatable in directions 32 and 34 (see FIG. 1b), so too are carriage bolt 30 and cam 20. It is appreciated that the illustrative configuration of cam 20 is such that at a location spaced apart from its axis 22, the radial length of cam 20 can change relative to the frame axis 13 (FIG. 2c) as cam 20 rotates. (See also FIG. 3a.) It is appreciated that other fasteners and means of attaching rotating cam 20, including but not limited to integral casting enhancements, may be used.

The views of FIGS. 1d-g illustratively demonstrate how frame 10 can be coupled to pipes or tiles having diameters ranging illustratively from 15 inches to 21 inches. For example, as shown in FIG. 1d, tile 36 is a 15 inch diameter tile. The first and second stops 16 and 18 engage the outer surface of tile 36. Then cam 20 can be rotated about axis 22 in directions 32 or 34 until cam 20 engages the outer periphery of tile 36 and pushes against the same to position and assist holding frame 10 in place against stops 16 and 18. In an alternate configuration, when an 18 inch diameter tile is used, such as tile 38 shown in FIG. 1e, pins 16 and 18 may engage the inner surface of tile 38. Cam 20 is then rotated in direction 34 until it also engages the inner surface of tile 38. This creates a force that pulls frame 10 against tile 38 at stops 16 and 18 to position and assist holding the same. The view shown in FIG. 1f includes frame 10 engaging a 20 inch diameter tile 40. In the illustrative configuration shown, stops 24 and 26 engage the inner surface of tile 40. Similar to the previous embodiments, cam 20 rotates about axis 22 until a portion of cam 20 engages the inner surface of tile 40 creating a horizontal pulling/holding force against stops 24 and 26. The view shown in FIG. 1g depicts frame 10 coupled with a 21 inch tile 42. Similar to the embodiment shown in FIG. 1f, stops 24 and 26 engage the inner surface of tile 42. Also similar to the previous description, cam 20 pivots about axis 22 until it engages the inner surface of tile 42, applying a pulling force, holding tile 42 against stops 24 and 26. This view further illustrates the utility of the illustrative shape of cam 20. Comparing FIG. 1g with FIG. 1f, the distance between axis of rotation 22 and the inner surface of the tile is much greater in FIG. 1g than in FIG. 1f. The shape of cam 20 (having a variable radial length, from axis 22, along its periphery) may, thus, accommodate tiles or pipes of different diameters. It is appreciated from the views of FIGS. 1d-g that tiles or pipes of a variety of diameters may employ any of the stops and cam at either the interior or exterior surfaces of the tiles to find an arrangement that will position the same. In this embodiment, all that is needed is engagement at three points where one of those points is adjustable. These views demonstrate how a single frame can be used to engage a variety of tile diameters. Furthermore, because such tiles may have varying wall thicknesses, frame 10 can be employed to accommodate the same. Even having a tile of a particular diameter, with either a thick or thin wall thickness, may determine whether the inner or outer surfaces of the tile or pipe engages the cam and stops.

The illustrative embodiment of cam 20 is shown in FIGS. 2a-c. As previously discussed, this illustrative embodiment employs a cam shape that makes radial lengths from the axis of rotation 22 varied along the circumference of cam 20, as represented by lengths 44, 46, 48, 50, and 52. It is appreciated that the indicated radial lengths are illustrative and any number of radial lengths can exist therebetween. The effect of this, however, is that when a pipe or tile of a given size engages two fixed stops and is some distance from axis of rotation 22 of cam 20, the same need only be rotated until it fills that distance. In essence, this embodiment cam 20 wedges itself against either the inner or outer wall surface of the tile or pipe and axis of rotation 22. The embodiment of cam 20 shown in FIG. 2b further discloses a bore 54 which is illustratively configured to receive carriage bolt 30. (See FIG. 1c.) It is appreciated, however, that a cam of different configuration can be employed to accomplish the same function, as disclosed with cam 20.

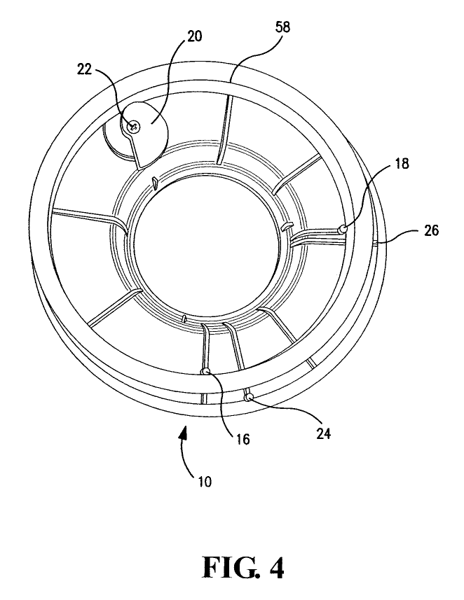

The underside perspective views of FIGS. 3 and 4 depict frame 10 engaging pipes 56 and 58 which have different diameters. In the view shown in FIG. 3, stop 16 (and 18 not shown in this view) engage the outer surface of pipe 56. Cam 20 is rotated about its axis of rotation 22 until it also engages the outer surface of pipe 56, wedging the same between these three points of contact. As similarly shown in FIG. 4, the inner surface of pipe 58 engages stop 16 and 18. Cam 20 is also rotated about axis of rotation 22 until it too engages the inner surface of pipe 58, again wedging the same between the illustrative three points of contact.

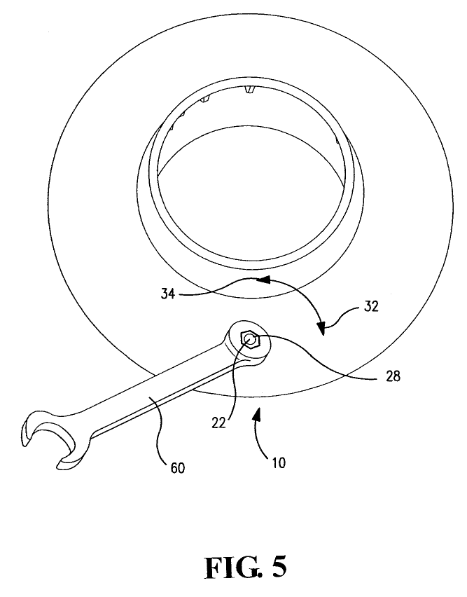

The top perspective view of FIG. 5 depicts how cam 20 of frame 10 moves to engage the tile or pipe. This view is of the upper side of frame 10, opposite the side that engages the pipe or tile, and demonstrates how cam 20 can be rotated. This mechanism addresses how cam 20 is rotated when frame 10 is located on top of a pipe or tile essentially vertically inserted into the ground. In the illustrative embodiment shown, a wrench 60 or other functional tool can engage torque head 28 and rotate same in either directions 32 or 34. This rotation rotates cam 20 underneath. When installing frame 10 on a tile or pipe, torque head 28 is simply rotated until cam 20 wedges the pipe or tile against the other stops in the manner previously discussed. It is appreciated from these views how the frame can be easily installed and held in position on the pipe or tile.

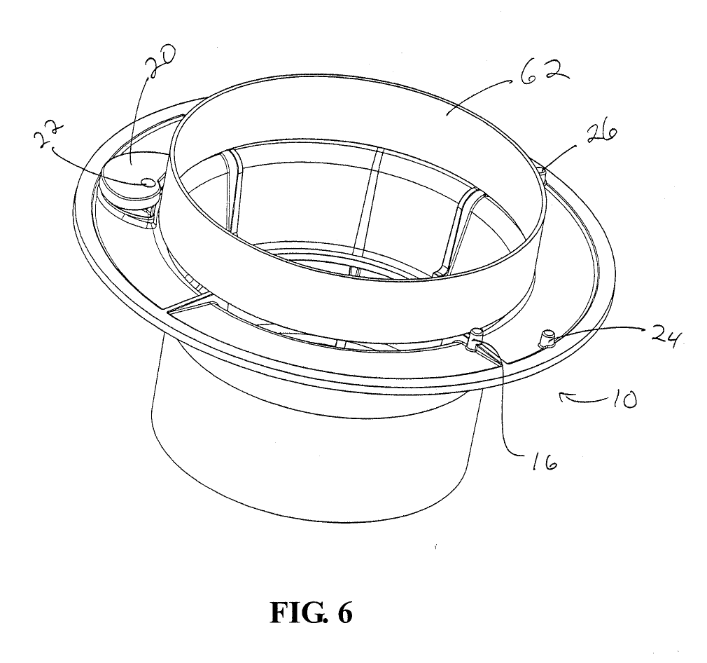

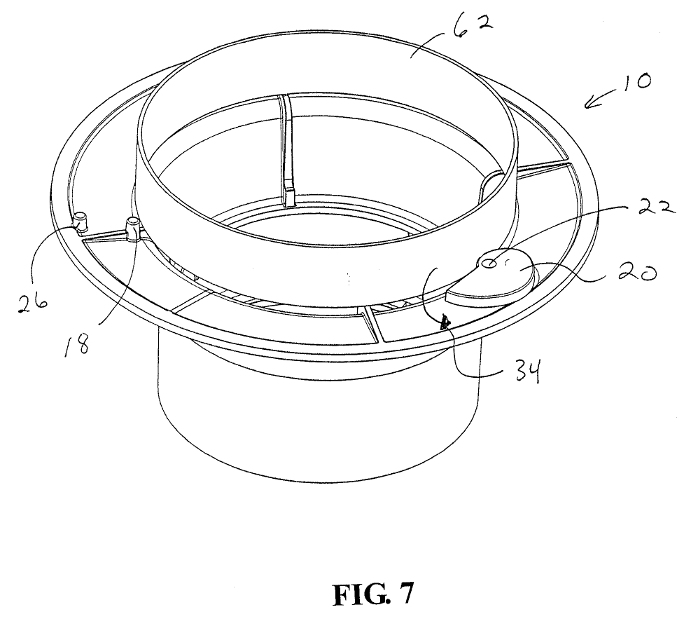

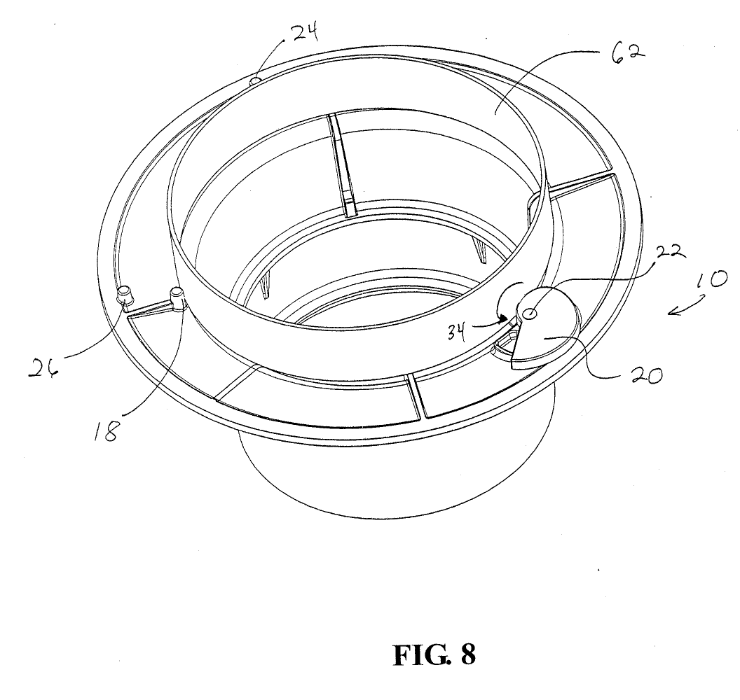

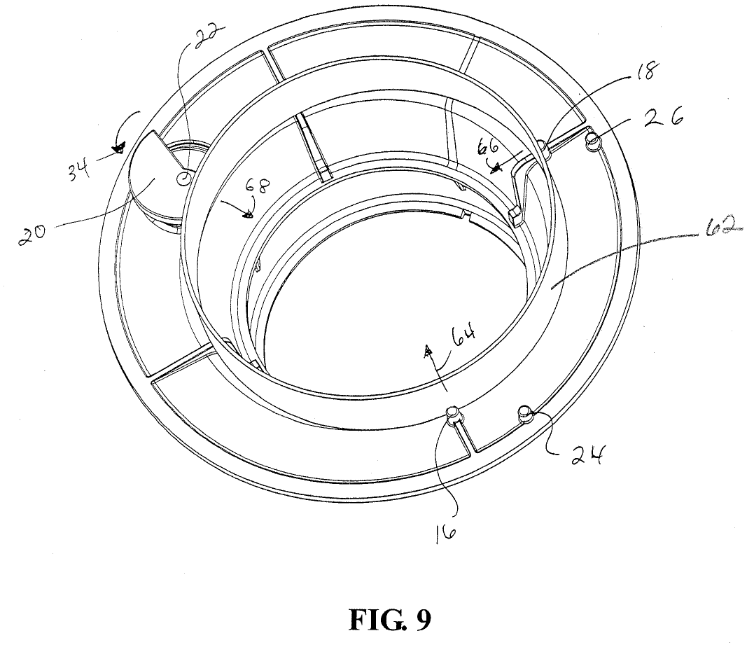

The underside perspective views of frame 10 shown in the progression views of FIGS. 6-9 demonstrate how cam 20 is rotated to engage tile 62. As shown in FIG. 6, tile 62 is located on the underside of frame 10 and rests within pins 18 (not shown in this view) and 16. At this position, cam 20 and pins 16 and 18 might not be engaging outside the surface of tile 62. As shown in FIG. 7, cam 20 can be rotated in direction 34 about axis 22. In this illustrative embodiment, as cam 20 rotates about axis 22, its radial length (relative to tile 62) increases. It is appreciated, however, that this configuration is illustrative and other configurations to accomplish the same result are contemplated to be within the scope herein as additional embodiments. As shown in FIG. 8, cam 20 rotates further in direction 34, thereby increasing the radial length of cam 20 with respect to the proximate exterior surface of tile 62 and abutting the same. When this occurs, additional wedging force is applied by cam 20 against tile 62, as shown in FIG. 9. Wedging tile 62 between stops 16, 18, and cam 20 essentially creates a compressive force at each point of contact, as indicated by reference numbers 64, 66, and 68, respectively. This force positions tile 62 in place against frame 10. It is appreciated that in other configurations, when the stops and cam or other adjustment member(s) engage the interior surface of the pipe or tile, resistance of forces are employed by the frame to position itself upon the pipe or tile.

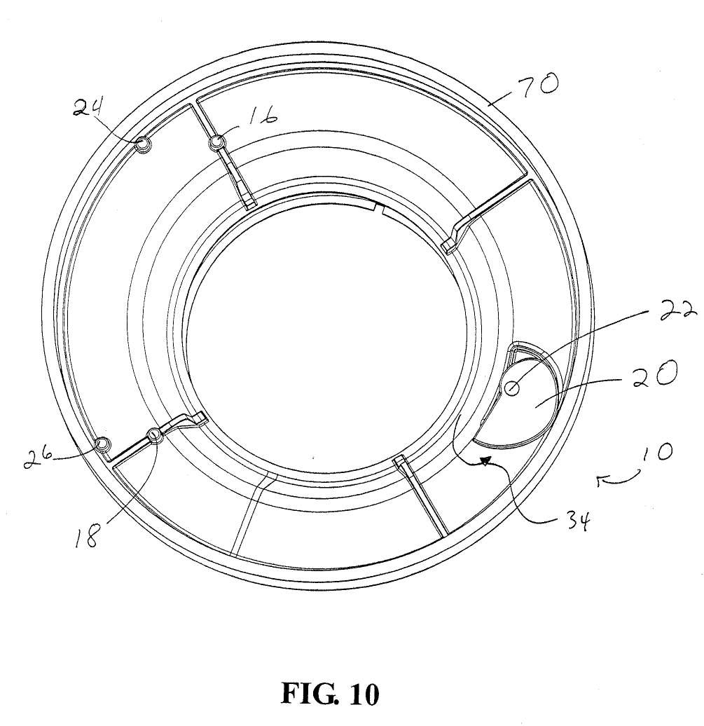

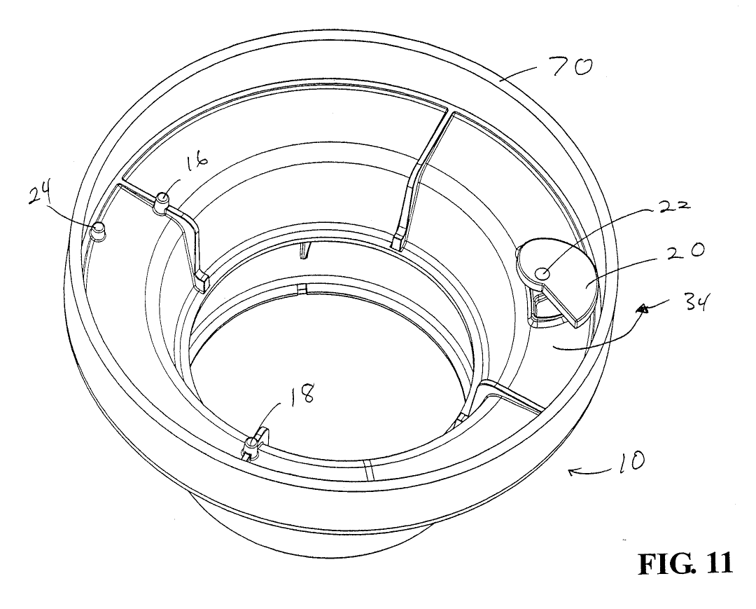

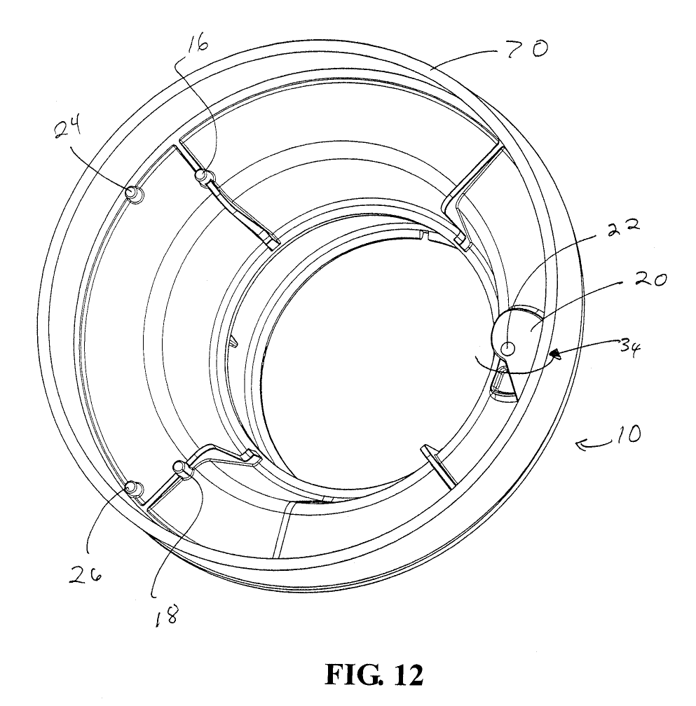

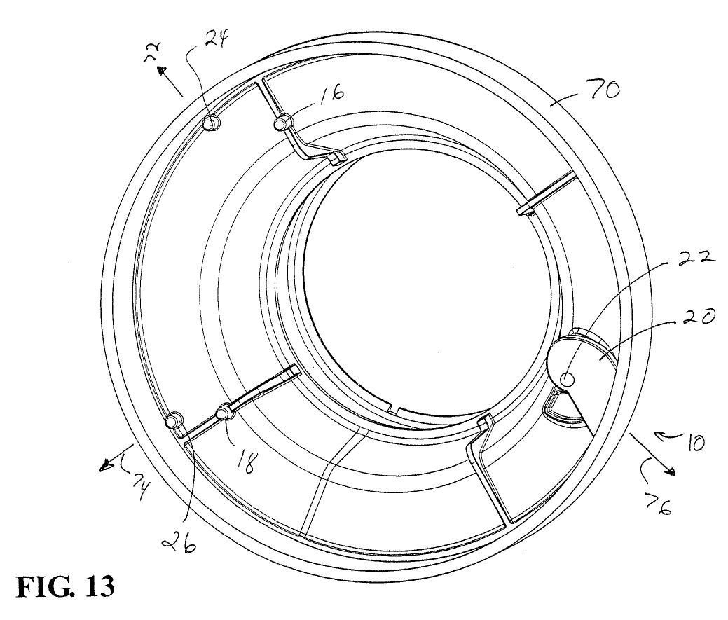

The perspective views of frame 10 shown in FIGS. 10-13 are progression views showing another illustrative configuration that can be employed depending on the tile diameters. As illustratively shown herein, tile 70 has a larger diameter than tile 62 shown in FIGS. 6-9. Accordingly, stops 24 and 26 can engage the interior surface of tile 70, as does cam 20, as shown in FIG. 10. This progression is similar to that of FIG. 6-9 in that as cam 20 rotates in direction 34, its radial length expands with respect to tile 70 until it engages the interior wall of tile 70. It is notable from the view in FIG. 10 that the interior surface of tile 70 is positioned a distance from axis of rotation 22 greater than that of the outer surface of tile 62. (See also FIG. 6.) In any event, as shown in FIG. 11, as cam 20 rotates in direction 34, its expanding radial length engages the interior wall of tile 70. The view of FIG. 12 continues this trend. By continuing to rotate cam 20 in direction 34, a wedging force is created and, in this particular configuration, stops 24, 26, and cam 20 create outwardly directed forces 72, 74, and 76 (see FIG. 13), respectively, to position frame 10 in place upon tile 70. It can be appreciated by contrasting progression views of FIGS. 6-9 and 10-13, that a variety of configurations between stops/cam and the particular tile or pipe can be employed to hold the same.

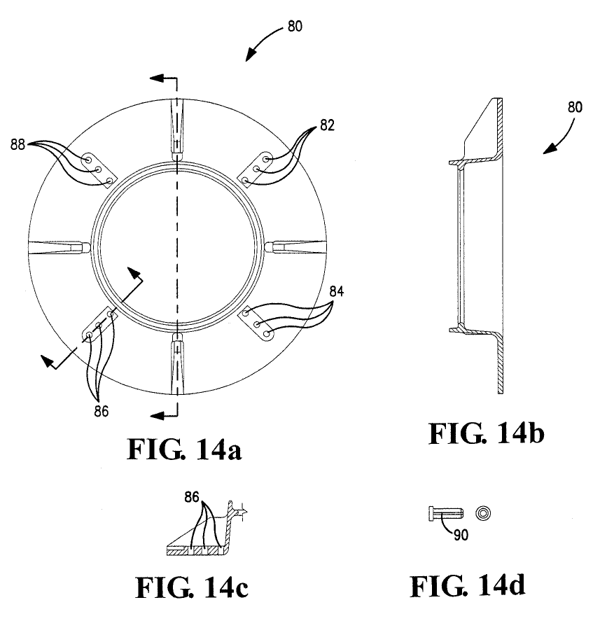

FIGS. 14-16 depict alternate embodiments of an adjustable frame for a cover assembly. For example, frame 80 shown in FIGS. 14a and b, employs a hole and pin arrangement to position the cover assembly on pipes or tiles of a variety of sizes. Frame 80 may include a plurality of holes 82, 84, 86, and 88 that are spaced apart in a particular arrangement. In FIG. 14a pins 90 can be placed in any of the holes 82-88 in a two, three, or four pin arrangement to provide stopping structures similar to the previous embodiments. (See FIG. 14d.) A distinction here is that adjustability comes from the variable placement of the pins themselves, rather than a moving stop structure. In an alternative embodiment, a series of fixed stops may extend from various locations on the underside of frame 80 to engage tiles or pipes of a variety of sizes.

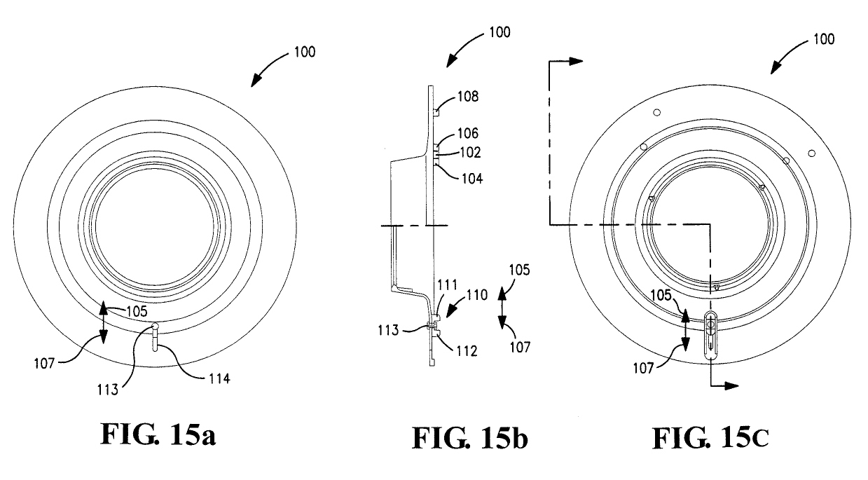

The illustrative embodiment shown in FIG. 15 includes several views of frame 100 having spaced apart stops 102, 104, 106, and 108 (see FIG. 15b), similar to that shown in frame 10. In this example, however, a sliding stop assembly 110 which comprises illustrative stops 111 and 112 is movable in directions 105 and 107. A fastener 113 may extend through a slot 114 (see FIG. 15a) disposed through frame 100 forming a path of travel. Either stop 111 or 112 (see FIG. 15b) may be moved along slot 114 (see FIG. 15a) to engage the inner or outer surface of the tile or pipe, depending on its size. Fastener 113 (see FIG. 15a) can be tightened or loosened to assist holding or removing frame 100 to or from the tile or pipe.

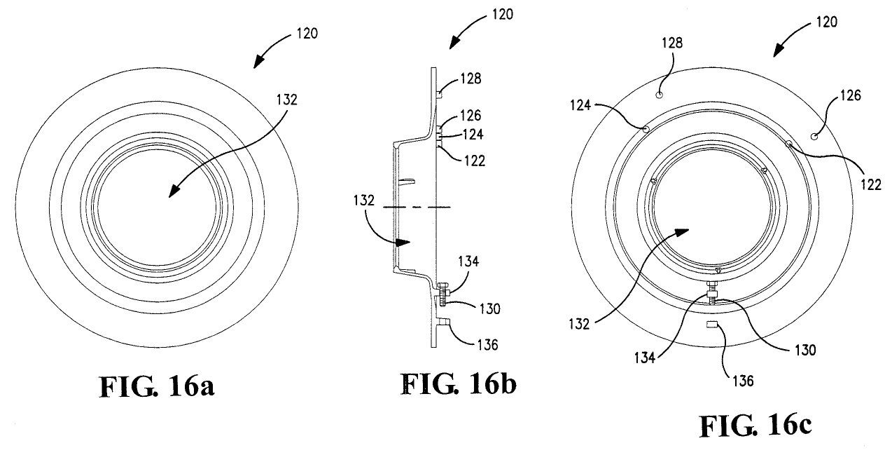

Frame 120 shown in FIGS. 16a-c also has stops 122, 124, 126, and 128 configured similar to the previous embodiments. Here, however, a threaded bolt can be used similar to a set screw to engage the pipe or tile. In one embodiment the head of the screw 130 is accessible through the ring opening 132. It is appreciated, however, that a flange 136, similar to flange 134 presently receiving bolt 130, can be used to receive a bolt and engage the outer surface of a pipe or tile.

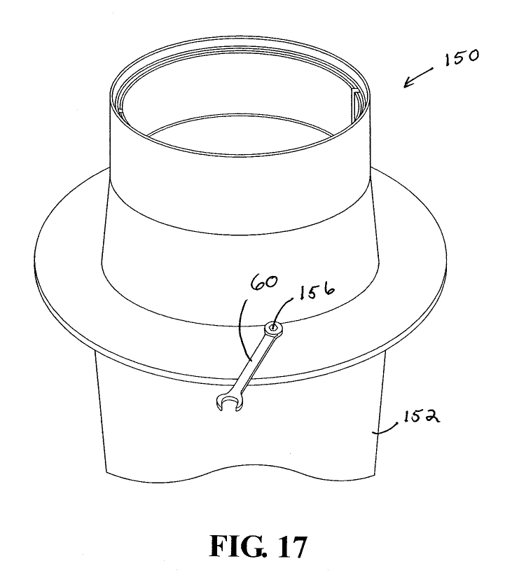

The top perspective view of FIG. 17 depicts a frame 150 coupled to a pipe 152. Wrench 60 engages fastener 156 to rotate a cam (not shown) or other adjustable lug underneath the frame to secure it to pipe 152.

Although this disclosure has been described with reference to particular means, materials and embodiments, from the foregoing description, one skilled in the art can easily ascertain the essential characteristics of the present disclosure, and various changes and modifications may be made to adapt the various uses and characteristics without departing from the spirit and scope of the present invention as set forth in the following claims.

What is claimed is:

1. A pit cover assembly comprising:
a base having a hole disposed therethrough;
wherein the base includes first and second surfaces;
a riser extending from the base on the second surface and located about the periphery of the hole;
a plurality of surfaces extending from the first surface, spaced apart from each other, and configured to engage a pit wall;
wherein each of the surfaces are located on the first surface of the base a radial distance from the hole; and
wherein at least one of the surfaces is radially adjustable with respect to the hole.

2. The pit cover assembly of claim 1, wherein the surfaces including the one radially adjustable surface, accommodate pits of various diameters to allow communication between the hole in the base and an opening of the pit.

3. The pit cover assembly of claim 1, wherein the radially adjustable surface is a cam that selectively adjusts radially from the hole to engage pits of various diameters to vertically position the base on the pit.

4. The pit cover assembly of claim 3, wherein the cam is rotatable such that its radial length is changeable with respect to its radial distance from the hole in the base so as to engage pits having various diameters to vertically position the base on the pit.

5. The pit cover assembly of claim 3, wherein the cam is rotatable about an axis to change the radial length of the cam with respect to its radial position to the hole.

6. The pit cover assembly of claim 5, further comprising a pivot that extends through the base so the cam is adjustable from the second surface.

7. The pit cover assembly of claim 6, wherein the pivot is a fastener that extends through the base to the second surface.

8. The pit cover assembly of claim 7, wherein the fastener is accessible from the second surface of the base to adjust the cam.

9. The pit cover assembly of claim 7, wherein the plurality of surfaces other than the adjustable surface are fixed lugs.

10. The pit cover assembly of claim 9, wherein the plurality of fixed lugs includes two fixed lugs each spaced apart from each other and spaced radially from the hole opposite the cam.

11. The pit cover assembly of claim 10, wherein each lug and the adjustable cam are configured to engage the pit wall to vertically position the base with respect to the pit wall.

12. The pit cover assembly of claim 9, wherein the plurality of fixed lugs are two sets of two fixed lugs each spaced apart from each other and spaced radially from the hole opposite the cam; and wherein a first set of fixed lugs is configured to engage the pit, and a second set of fixed lugs is configured to engage the pit.

13. A pit cover assembly comprising:
a base having a hole disposed therethrough;
wherein the base includes first and second surfaces;
a plurality of lugs extending from the first surface, spaced apart from each other, and radially spaced from the hole; and
a cam lug extending from the first surface at a pivot that rotates the cam lug;
wherein the cam lug has a plurality of surfaces each having a unique radial distance from the pivot such that rotating the cam lug changes a radial distance from any one of the plurality of surfaces to the hole.

14. The pit cover assembly of claim 13, wherein the pivot that extends through the base is accessible from the second surface to adjust the cam lug from the second surface.

15. The pit cover assembly of claim 14, wherein the pivot is a fastener that extends through the base to the second surface.

16. A pit cover assembly comprising:
a means for engaging and covering a pit;
wherein the means for engaging and covering the pit includes an adjustment means for engaging pit walls of varying diameters; and
wherein the means for engaging and covering the pit is horizontally positionable on the pit walls.

17. The pit cover assembly of claim 16, wherein the adjustment means for engaging pit walls of varying diameters is adjustable and horizontally positionable exterior of the pit.
